(19) United States
(12) Patent Application Publication
(10) Pub. No.: US 2012/0330741 A1
(43) Pub. Date: Dec. 27, 2012

(54) PROMOTION SYSTEM AND METHOD

(76) Inventor: Joshua Cruz, McAllen, TX (US)

(21) Appl. No.: 13/166,643

(22) Filed: Jun. 22, 2011

(51) Int. Cl. G06Q 30/00; G06Q 90/00

(52) U.S. Cl. 705/14.31; 705/500

(57) ABSTRACT

Provided is a method for providing a promotional instrument. The method includes determining a number and/or value of promotional instruments purchased and assigning, by a promotion system, a promotional incentive based at least in part on the number and/or value of promotional instruments purchased.

### BACKGROUND

1. Field of the Invention

The present invention generally relates to a system and method for providing promotions, and more particularly to providing varying incentives based on promotional offer participation levels.

2. Description of Related Art

Goods and services providers often provide various types of promotional campaigns to help drive consumer demand for their products. In many instances, a business will issue coupons, vouchers, or other promotional materials that can be redeemed for a financial discount, credit, or rebate toward the purchase of a good or service. For example, a $10 coupon issued by a restaurant may be redeemed by a consumer for $10 toward the purchase of dinner at the restaurant. Often, coupons are sold to consumers at a cost that is less than their redemption value. For example, a coupon/voucher issued by a restaurant and purchased by a consumer for $5 may have a redemption value of $10. Thus, the coupon/voucher may be redeemed by the consumer for $10 toward the purchase of a dinner at the restaurant. Often, these coupons/vouchers have a static redemption value. That is, the redemption value remains the same, irrespective of the number of other coupons/vouchers issued or sold. Unfortunately, such a static redemption value may not enable a business to vary the value as an incentive to drive consumer demand and awareness for their product. For example, although total expected profit may increase as the number of coupons/vouchers issued increases enabling, the business to offer even larger discounts, the static nature of the coupons/vouchers issued may limit the redemption value to the values set at the time of issue. As a result, there is no substantial incentive for a coupon/voucher holder to encourage other consumers to take part in the promotional campaign (e.g., purchase additional coupons), or even redeem the coupon/voucher themselves. As a result, product sales and exposure may not meet their full potential.

Accordingly, there is a desire to provide techniques for providing promotional incentives of varying value based on participation with a promotional offer.

### SUMMARY

Various embodiments of promotional techniques, related apparatus, and methods of operating the same are described. In one embodiment, provided is a method for providing a promotional instrument. The method includes determining a number and/or value of promotional instruments purchased and assigning, by a promotion system, a promotional incentive based at least in part on the number and/or value of promotional instruments purchased.

In another embodiment, provided is a non-transitory computer readable storage medium comprising program instructions stored thereon. The program instructions are executable by a computer device to cause: determining a number and/or value of promotional instruments purchased, and assigning a promotional incentive based at least in part on the number and/or value of promotional instruments purchased.

In another embodiment, provided is a system for conducting promotions. The system includes a promotional instrument coordinator comprising a processing module to determine a number and/or value of promotional instruments purchased, and assign a promotional incentive based at least in part on the number and/or value of promotional instruments purchased.

### BRIEF DESCRIPTION OF THE DRAWINGS

Advantages of the present invention will become apparent to those skilled in the art with the benefit of the following detailed description and upon reference to the accompanying drawings in which:

FIG. 1 is a schematic diagram that illustrates a promotion system in accordance with one or more embodiments of the present technique;

FIG. 2 is a diagram that illustrates the promotion system in accordance with one or more embodiments of the present technique;

FIG. 3 is a flowchart that illustrates a method of providing promotions in accordance with one or more embodiments of the present technique; and

FIG. 4 illustrates an exemplary computer system in accordance with one or more embodiments of the present technique.

While the invention is susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF ILLUSTRATIVE EMBODIMENTS

As discussed in more detail below, certain embodiments of the present technique include systems and methods for implementing promotions. In some embodiments, promotions include issuing coupons, vouchers or similar promotional materials (collectively referred to herein as coupons/vouchers) that have a variable redemption value and/or associated incentives that are dynamically assigned based on one or more factors, such as participation in a corresponding promotional offer. In certain embodiments, a redemption value for a coupon/voucher is based at least in part on a number of coupons/vouchers issued and/or purchased.

As used herein, “coupon” refers to an instrument (e.g., ticket, document, etc.) that can be exchanged for a financial discount or rebate for the purchase of a product (e.g., a good or service). A coupon may be distributed through physical media (e.g., mail, magazines, newspapers, flyers, etc.), electronic media (e.g., the internet, websites, e-mail, cellular devices, etc), or the like. A coupon may be issued to a consumer with or without an exchange of consideration for the coupon.

As used herein, “voucher” refers to an instrument (e.g., receipt) that authorizes disbursement of cash or credit against a future purchase of a product (e.g., a good or service) or expense. A voucher may include a document (e.g., receipt, stamp, etc.) that gives evidence of consideration (e.g., a monetary expenditure) provided. A voucher may be distributed through physical media (e.g., mail, magazines, newspapers, flyers, etc.), electronic media (e.g., the internet, websites, e-mail, cellular devices, etc), or the like. A voucher may be issued to a consumer with or without an exchange of consideration for the voucher.

A used herein, “purchased coupon” or “purchased voucher” respectively refer to a coupon or voucher that is purchased by a consumer for a given amount of consideration. A purchased coupon/voucher may have a redemption value that exceeds the amount of consideration paid by the consumer. For example, a “purchased coupon” or “purchased voucher” may refer to a coupon/voucher purchased by a consumer for $5, and having a redemption value of $10 toward goods or services provided by a vendor.

A used herein, the term “promotion instrument” refers to an instrument that is redeemable for a credit or rebate for the purchase of a good or service. The term promotional instrument may include a coupon, a voucher, and/or a purchased coupon/voucher.

A used herein, the term “purchased promotion instrument” refers to a promotional instrument that is purchased by a consumer for a given amount of consideration. A purchased promotional instrument may have a redemption value that exceeds the amount of consideration paid by the consumer.

In some embodiments, the value of a promotional instrument (e.g., a voucher/coupon) and/or associated incentives depends on the number of persons who commit to, or otherwise take part in, a promotional campaign (e.g., a given coupon/voucher offer). For example, a coupon/voucher having an initial redemption value of $10 may be made available for purchase price of $5. Thus, a consumer may redeem the coupon for at least a $10 benefit toward good and services. However, as the number and/or value of coupons/vouchers issued (e.g., purchased) increases for the offer, the coupon/voucher may increase in value. For example, a coupon having the initial value of $10 may increase in value to $15 if a given number and/or value of coupons is sold to consumers. In some embodiments, the value may increase in view of various additional incentives in place of or in combination with a monetary increase in value. Incentives such as additional products (e.g., “add-ons”), credits, donations, additional coupon/vouchers may be provided in association with the coupon/voucher. For example, a coupon/voucher may be redeemed for a monetary credit of $15 and a free gift if a given number and/or value of coupons/vouchers is sold to consumers. In some embodiments, the number and/or value of incentives increase proportionally. For example, the monetary redemption value may increase by a value 1% of the total number and/or value of coupons sold. In some embodiments, the number and/or value of incentives increase based on satisfying one or more thresholds, such as a threshold number and/or value of coupons sold. For example, the redemption value may increase from $10 to $15 if three-hundred coupons are sold. In some embodiments, the number and/or value of incentives increase incrementally based on satisfying incremental thresholds for the number and/or value of coupons sold. For example, the redemption value may increase by $1 for every fifty coupons sold. In some embodiments the redemption value may be limited to a maximum amount. For example, the redemption value may be capped at $20 regardless of the number and/or value of coupons/vouchers issued.

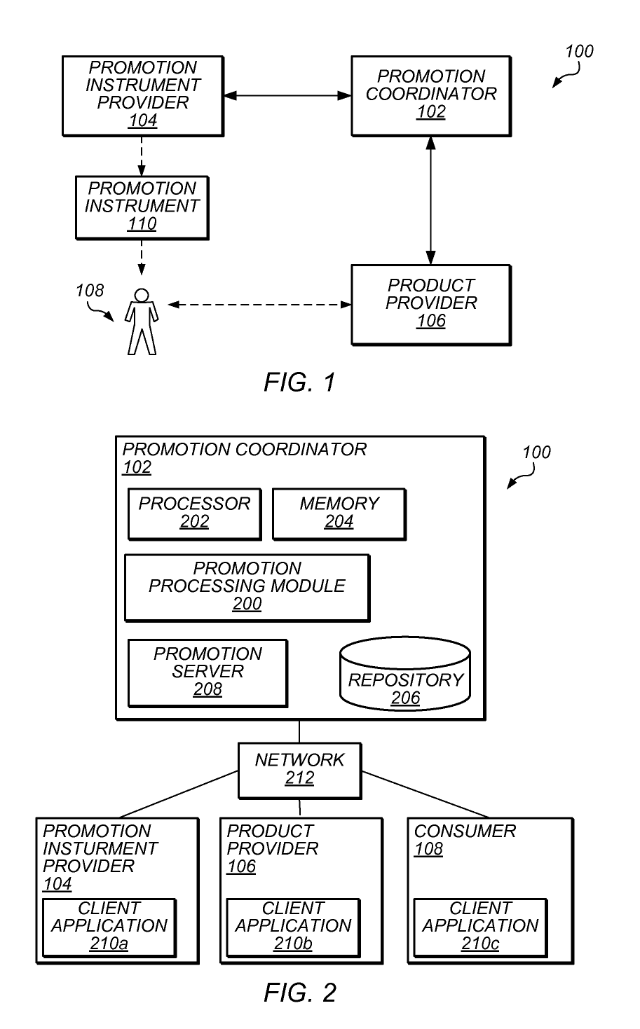

FIG. 1 is a schematic diagram that illustrates a promotion system 100 in accordance with one or more embodiments of the present technique. In the illustrated embodiment, promotion system 100 includes a promotion coordinator 102, a promotion instrument provider 104, a product provider 106 and a user (e.g., consumer) 108. A promotional instrument (e.g., coupon/voucher) 110 may be provided and/or redeemed via promotional system 100. For example, a coupon/voucher 110 may be issued to consumer 108 (e.g., purchased by consumer 108) from promotion instrument provider 104, and consumer 108 may redeem coupon/voucher 110 at product provider 106 in exchange for credit towards goods and/or services provided by product provider 106. In some embodiments, promotion coordinator 102 may track the number and/or value of coupons/vouchers issued in association with a promotional offer/campaign, and may assign incentives (e.g., a monetary redemption value and/or other incentives) to coupon/voucher 110 based on the number and/or value of coupons/vouchers issued. For example, the redemption value of coupon/voucher 110 may be increased if a threshold number and/or value of coupons/vouchers sold is satisfied. The redemption value may include a monetary value, credits, additional products/gifts (e.g., “add-ons”), gifts, or other incentives to consumers.

Promotion instrument 110 may include a coupon, voucher, purchased coupon, purchased voucher, purchased promotion instrument, or the like. For example, promotion instrument 110 may include a purchase coupon/voucher that is purchased by a consumer for $5 and is redeemable at a restaurant for a $10 credit toward the purchase food at the restaurant. In the context of providing promotional coupons/vouchers (e.g., where promotion instrument 110 includes a coupon or voucher), promotion coordinator 102 may be referred to as “coupon/voucher coordinator” and promotion instrument provider 104 may be referred to as “coupon/voucher provider”.

Promotion instrument 110 may include physical media (e.g., mail, magazines, newspapers, flyers, paper coupons, etc.), electronic media (e.g., media provided via the internet, websites, e-mail, computers, cellular devices, personal digital assistant (PDA), software applications, etc.), or the like. Promotion instrument 110 may be printed (e.g., on a physical sheet of paper) or rendered on a display of an electronic device (e.g., a display of a cellular phone) for presentation to a product provider for redemption. Presenting promotion instrument 110 may entitle the consumer to a credit toward the purchase price of a good or service, discounts, promotional gifts, credits, etc. For simplicity of description, several of the embodiments described herein refer simply to coupons and/or vouchers, although it will be appreciated that each of these embodiments may include any form of promotional instruments, including, for example, a coupon, a voucher, a purchased coupon, a purchased voucher, and/or other purchased promotion instruments.

Product provider 106 may include a business or other establishment that provides products (e.g., good and/or services) to consumers. In some embodiments, product provider 106 may include a restaurant, a brick-and-mortar retail business, an online/internet vendor/retailer, or the like. For example, product provider 106 may include a restaurant frequented by consumer 108. Product provider 106 may receive consideration (e.g., monetary payments) from consumers in exchange for providing products (e.g., food) to consumers. In some embodiments, product provider 106 may issue, or otherwise authorize the distribution of, promotional instruments 110 (e.g., coupons) that can be redeemed by consumers 108. Product provider 106 may directly issue coupons/vouchers to consumers. For example, product provider 106 may handouts coupons/vouchers to consumers during their visit to the product provider's place of business, or may themselves conduct a promotional campaign of distributing coupons/vouchers to consumers. Product provider 106 may authorize indirect issue coupons/vouchers to consumers. For example, product provider 106 may retain an advertising agency or promotions firm to generate and/or issue coupons/vouchers to consumers (e.g., via mailers, internet websites, e-mail, etc.).

Promotion instrument provider 104 may issue or otherwise distribute promotional instruments (e.g., coupons/vouchers). Promotion instrument provider 104 may provide coupons/vouchers 110 to consumers via physical media (e.g., mail, magazines, newspapers, flyers, paper coupons, etc.), electronic media (e.g., media provided via the internet, websites, e-mail, computers, cellular devices, personal digital assistant (PDA), software applications, etc.), or the like. In some embodiments, promotion instrument provider 104 may offer coupons/vouchers to consumers via a web-site or e-mail directed to the consumer and/or may provide the consumer an opportunity to receive, purchase, or otherwise commit to the offer for coupons/vouchers via the web-site, e-mail, phone, mail, etc. For example, promotion instrument provider 104 may send to multiple consumers 108, e-mails describing coupons/vouchers that are available for purchase (e.g., a coupon/voucher for $10 credit toward the purchase food at the restaurant that can be purchased for $5). Consumers may subsequently visit a website of promotion instrument provider 104 to submit an electronic payment of $5 (e.g., using their credit-card) to purchase the coupon/voucher. Upon purchase, promotion instrument provider 104 may transmit the corresponding coupon/voucher to consumer 108 via e-mail or other form of transmission (e.g., website, mail, etc.). The coupon/voucher may be printed (e.g., printed on a sheet of paper) or rendered on a display of an electronic device (e.g., rendered on a display of a cellular phone) for presentation to the restaurant for redemption. Presenting the coupon/voucher to product provider 106 may entitle the consumer to $10 off of the purchase price of their meal at the restaurant.

In some embodiments, promotion instrument provider 104 provides various details relating to the promotion instrument 110. Promotion instrument provider may provide terms describing how the value of a coupon/voucher is determined. For example, promotion instrument provider 104 and/or coupon/voucher 110 may state: “This coupon/voucher has an initial monetary redemption value of $10 . . . . The monetary redemption value increases by $2 for every fifty coupons issued/purchased over the next seven days (i.e., by April 8^{th}), up to a maximum redemption value of $20.” The terms may be provided along with the original offer (e.g., within the e-mail containing the offer) and/or in response to a query from the consumer regarding the offer. Promotion instrument provider 104, promotion coordinator 102 and/or product provider 106 may provide consumer with updates relating to the status of the coupon/voucher. For example, promotion instrument provider 104, promotion coordinator 102 and/or product provider 106 may send periodic updates or respond to consumer queries with information regarding the current assigned incentives (e.g., monetary redemption value and/or other incentives) and/or the number and/or value of promotion instruments purchased. Thus, consumer 108 may be informed of the redemption value and/or the potential for change in the redemption value of vouchers/coupons.

Promotion coordinator 102 may provide for coordination of various aspects of issuing, valuing, and redemption of promotional instruments. In some embodiments, promotion coordinator 102 tracks the number and/or value of coupons/vouchers that have been issued to consumers. For example, promotion instrument provider 104 may inform promotions coordinator 102 of the number and value of coupons/vouchers purchased by consumers for a given offer. In some embodiments, promotion coordinator 102 may assess the information to determine a corresponding number and/or value of coupons/vouchers issued. Promotion coordinator 102 may determine and assign incentives (e.g., a monetary redemption value and/or other incentives) to coupons/vouchers based on the determined number and/or value of coupons/vouchers issued/sold. Promotions coordinator 102 may provide to product provider 106, information regarding the number and/or value of coupons/vouchers issued/sold and/or the assigned incentives. Product provider 106 may use at least this information to determine and/or provide appropriate incentives for coupons/vouchers received from consumers 108.

Consumer 108 may refer to a person(s) that obtain one or more promotion instruments 110 issued by promotion instrument provider 104, and/or a person(s) that redeem one or more promotion instruments 110 at a participating product provider 106. For example, in the context coupons for a restaurant, consumer 108 may include a consumer that purchases a coupon for $5 at a restaurant brick-and-mortar retail location or a website operated by the restaurant or an advertising/marketing agency, and later redeems that $5 coupon at the restaurant's brick-and-mortar retail location for a $10 credit toward the purchase of food or other products.

In some embodiments, some or all of the entities of promotions system 100 may be communicatively coupled to one another via an electronic communications network (e.g., network 112 described below) to facilitate the exchange of information (e.g., coupons/vouchers, number/value of coupons sold, redemption values, etc.) there between.

In some embodiments, one or more entities of system 100 and/or their responsibilities may be combined/shared. In some embodiments, promotional instrument provider 104 may be integral with or the same as product provider 106. For example, a restaurant that both, issues and accepts coupons, may act as a promotion instrument provider 104 when the restaurant provides a coupon/voucher to a consumer during a first visit to the restaurant, and may act as a product provider 106 when the restaurant subsequently receives and redeems the coupon/voucher for credit toward the consumer's meal at their next visit.

In some embodiments, promotional instrument provider 104 may include an entity that is separate from product provider 106. For example, a restaurant may employ an advertising/marketing firm to provide a promotional campaign distributing coupons/vouchers to consumers (e.g., via mailers, internet websites, e-mail, etc.). In such embodiments, the advertising/marketing firm may act as a promotion instrument provider 104, and the restaurant may act as product provider 106 when the restaurant subsequently receives and redeems the coupons/vouchers for credit toward the consumer's meal at their next visit.

In some embodiments, promotion coordinator 102, promotion provider 104 and/or product provider may be integral with one another. For example, promotion coordinator and promotion instrument provider 104 may include a single marketing/advertising agency employed by product provider 106 to engage in a marketing campaign, including the distribution of coupons/vouchers.

Although certain exemplary embodiments are discussed herein with regard to a single promotion instrument provider 104, a single product provider 106, a single consumer 108, and/or a single promotion instrument, embodiments of promotions system 100 may include any number promotion instrument providers, product providers, consumers, and/or promotion instruments. For example, promotion coordinator may coordinate one or more promotional campaigns that involve distribution of promotions instruments via a plurality of instrument providers with the promotion instruments redeemable at a number of different product providers.

FIG. 2 is a diagram that illustrates promotion system 100 in accordance with one or more embodiments of the present technique. In some embodiments, promotion coordinator 102 includes one or more promotion processing module(s) 200 configured to facilitate processing of information, including information exchanged with various other entities of system 100. Promotion processing module 200 may provided for determining the number and/or value of promotional instruments issued and/or determining and/or assigning incentives (e.g., monetary redemption value and/or other incentives) for promotional instruments.

In some embodiments, promotion coordinator 102 may include a processor for executing program instructions. For example processor 202 may execute program instructions of processing module(s) 200. In some embodiments, program instructions executed by processor 202 are stored in a memory 204. For example, processing module(s) 200 may include program instructions stored in memory 204. Memory 204 may include a non-transitory computer readable storage medium.

In some embodiments, promotion coordinator 102 includes a repository 206. Repository 206 may include a database or similar memory location for storing promotion information relating to various promotional campaigns, such as rules/instructions for determining incentives (e.g., a monetary redemption value and/or other incentives), threshold values, the number and/or value of coupons/vouchers issued/sold, etc. Repository 206 and/or memory 204 may be integrated into a single memory device, or may be separate from one another. In some embodiments, repository 206 may be located remotely (e.g., offsite) from other components of promotion coordinator 102. For example, repository 206 may include a separate remote and/or distributed database provided at another network location.

In some embodiments, promotion coordinator 102 may include a promotion server 208. Server 208 may provide for the exchange of data/information between promotion coordinator 102 and other entities (e.g., via network 212). For example, server 208 may enable promotion instrument provider 104, product provider 106, consumer 108 and/or other clients to exchange information with promotion coordinator 102 via client applications (e.g., client applications 210a-210c). Client application 210a-210c may include an internet browser or other application that facilitates electronic communication between entities. For example, a consumer 108 may simply log-in to a website of promotion coordinator 102 via client application 210c (e.g., internet browser) to retrieve a summary of an offer, including information relating to the incentives (e.g., a monetary redemption value and/or other incentives) assigned to or otherwise associated with a coupon/voucher they have purchased. Other entities may have similar networked access to information stored, processed and/or provided by transaction coordinator 102. In some embodiments, promotion instrument provider 104 and product provider 106 communicate with promotion coordinator 102 to exchange information relating to the issuance/sale of coupons/vouchers and/or incentives (e.g., a monetary redemption value and/or other incentives) assigned to or otherwise associated with a coupon/voucher. For example, client applications 210a, 210b and 210c may be used to provide or receive data relating to content of coupons/vouchers to be issued, the number of coupons/vouchers issued/sold, initial redemption values, assigned redemption values, etc. In some embodiments, the exchange of data may be automated. For example, queries and response may be automatically generated and transmitted between entities (e.g., promotion instrument provider 104, product provider 106 and/or promotions coordinator 102) upon a request from a consumer to obtain/purchase a coupon/voucher, upon commit to (e.g., payment for) a coupon/voucher, and/or upon a request from a consumer to redeem a coupon/voucher.

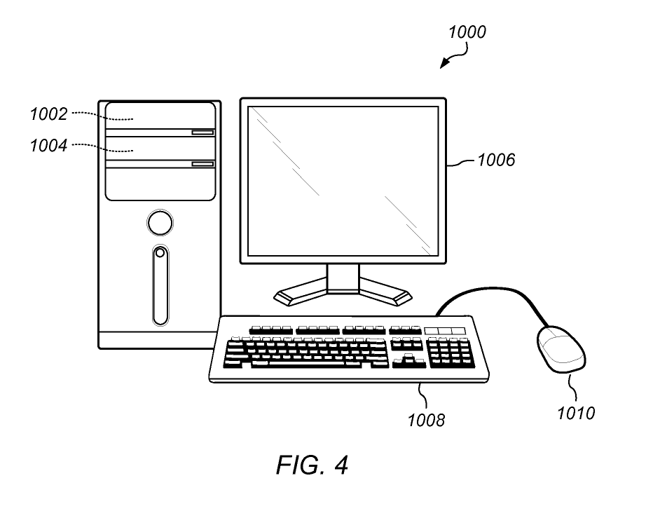

In some embodiments, promotion coordinator 102, promotion instrument provider 104, product provider 106, and consumer 108 may include/employ a computer system, such as exemplary computer system 1000 depicted and described with respect to FIG. 4.

Electronics communication network (“network”) 212 may include the internet, a local area network (LAN), a cellular communications network, or the like. Each of the entities connections to the network may include any variety of connection types capable of supporting communication between the various entities. For example, the connections may include connections via the internet, a local area network, a wireless cellular network, or various combinations thereof. The connections may include cabled or wireless connections. Cabled connections may refer to land-line telephone service, a cabled connection to an internet service provider, and/or hard-wired (local area network) LAN connections. Wireless connections may include forms of wireless telecommunication, such as wireless cellular communication networks, wireless LAN systems (e.g., wireless routers), and the like or various combinations thereof.

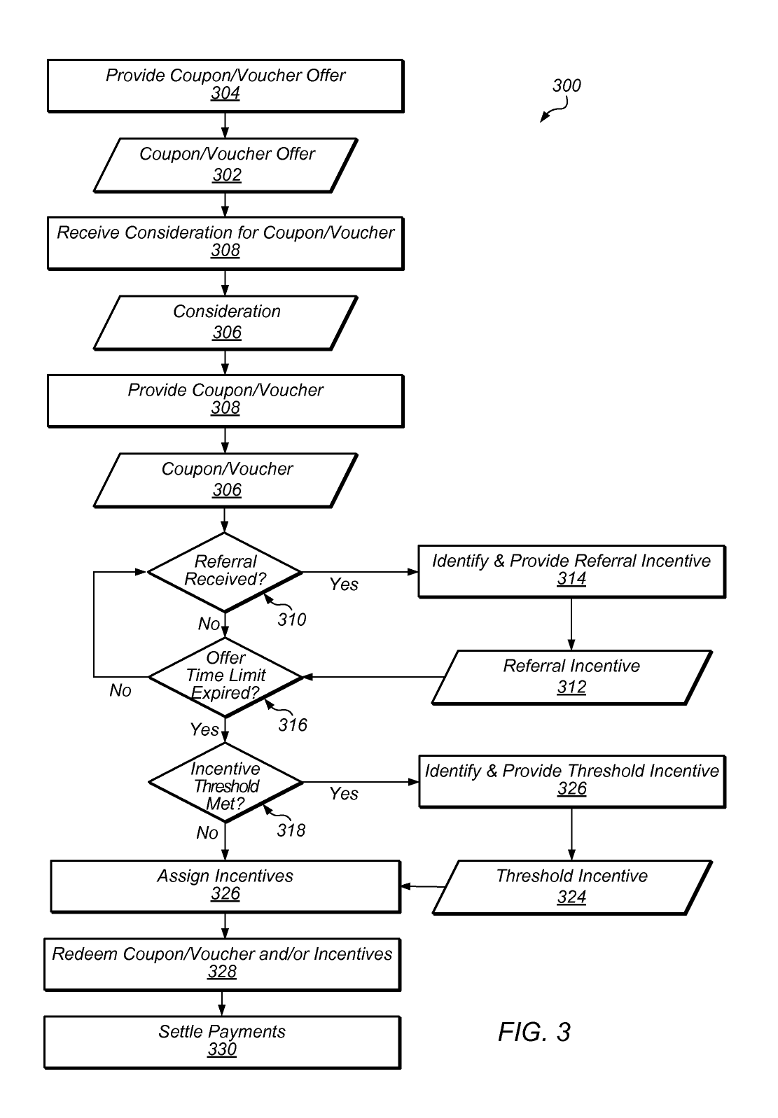

FIG. 3 is a flowchart that illustrates a method 300 of providing promotions in accordance with one or more embodiments of the present technique. Method 300 includes determining a number and/or value of promotional instruments purchased and assigning, by a promotion system, a redemption value for the promotional instrument based at least in part on the number and/or value of promotional instruments purchased. Some or all of method 300 may be performed by one or more of the entities of system 100. For example, promotion processing module 200 of promotion coordinator 102 may provide for some or all of the processing in accordance with method 300. It should be appreciated that embodiments described with respect to FIG. 3 are illustrative and are not intended to be limiting. For example, certain steps described with respect to method 300 may be modified, rearranged, removed, or duplicated.

Method 300 may include providing a promotional offer (e.g., a coupon/voucher offer) 302, as depicted at block 304. Providing a coupon/voucher offer 302 may include providing a consumer and opportunity to purchase or otherwise obtain a coupon/voucher that may be redeemed for value towards products and other incentives. For example, promotion instrument provider 104 may publish on a website or send via an e-mail to one or more consumers 108 advertising a coupon/voucher that is available for purchase. Coupon/voucher offer 302 may include terms of the offer, an initial/minimum redemption value, terms for dynamically assigning a redemption value (e.g., threshold issue/sales requirements), various incentives (e.g., a monetary redemption value and/or other incentives), time limits and locations for redeeming the coupon/voucher, etc. In some embodiments, the coupon/voucher offer and/or information relating thereto may be provided to promotion instrument provider 104 from promotion coordinator 102 and/or product provider 106.

Method 300 may include receiving consideration 306 for a coupon/voucher, as depicted at block 308. Receiving consideration for a coupon/voucher may include receiving a monetary payment for the purchase of the coupon/voucher. For example, upon reviewing coupon/voucher offer 302, consumer 108 may decide to purchase or otherwise commit to the purchase of the coupon/voucher, and may provide a corresponding payment to promotion instrument provider 104. In some embodiments, the payment may be provided in various manners, including, for example, an electronic payment (e.g., credit card) via a website of promotion instrument provider 104. Although some embodiments may require or otherwise involve purchase of the coupon/voucher, other embodiments may include “free” coupon/vouchers that require minimal or no consideration. For example, consumer 108 may only be required to indicate their desire to take part in the coupon/voucher offer 302. Such indication may enable tracking (e.g., counting) of the number and/or value of coupon/voucher offers 302 provided to consumers 108. In some embodiments, consumers 108 may receive coupon/voucher offer 302 without any consideration or indication of their desire to receive the coupon/voucher.

Information regarding the consumer's expressing their desire/commitment to take part in coupon/voucher offer 302 may be forwarded to promotion coordinator 102. For example, promotion instrument provider 104 may transmit an indication of the consumer's purchase, or other form of commitment to take part in the coupon/voucher offer, to promotion coordinator 102. Promotion coordinator 102 may use the indication to assess and determine the number and/or value of coupons/vouchers issued (e.g., purchased) for the offer/campaign.

Method 300 may include providing a coupon/voucher 306, as depicted at block 308. Coupon/voucher 306 may be similar to or the same as promotion instrument 110. Providing a coupon/voucher may include providing coupon/voucher to one or more consumers that have purchased or otherwise indicated their desire to take part in the coupon/voucher offer. For example, promotion instrument provider 104 may issue (e.g., send or transmit) coupon/voucher 306 to consumer 108 in response to receiving payment and/or the indication of the consumer's desire to take part in coupon/voucher offer 302.

In some embodiments coupon/voucher 306 may be associated with a unique identifier. For example, coupon/voucher may include a serial number that uniquely identifies the coupon/voucher from some or all of the other ones of the coupon/vouchers issued in the corresponding coupon/voucher offer and/or other promotional offers. In some embodiments, the serial number may be unique to the particular consumer. For example, the serial number may identify an account of consumer 108 with promotion system 100, such that purchase and/or redemption of coupon/voucher 306 may be associated with consumer 108. In some embodiments, associating coupon/voucher 306 and actions associated therewith (e.g., purchase and/or redemption) may enable system 100 to track involvement of consumer 108 such that appropriate incentives may be provided to consumer 108. For example, promotion coordinator 102 may track the number and/or value of coupons purchased by consumer 108 and associated activity (e.g., the total number of purchases and value of coupons by other consumers) such that credits (e.g., points redeemable for good and services, monetary value, etc.) may be issued to an account of consumer 108. The credits may be used, for example, for purchase of additional coupons, the receipt of gifts, etc.

Method 300 may include determining whether or not a referral has occurred, as depicted at block 310. A referral may include one consumer encouraging or otherwise causing another consumer to take part in a promotional offer, such as coupon/voucher offer 302. For example, a first consumer may notify another/second consumer about coupon/voucher offer 302, and may request that the second consumer indicate that they were referred by the first consumer (e.g., by providing the first consumer's name, user account serial number, or some other form of identification for the first consumer). Based on the referral, upon purchasing a coupon/voucher 306 or otherwise indicating their desire to take part in the coupon/voucher offer 302 or other promotional offer, the second consumer may indicate that they were referred by the first consumer. For example, the second consumer may provide the first consumer's name, user account serial number, or some other form of identification for the first consumer to promotion instrument provider 104 and/or promotion coordinator 102 in association with the second consumer's purchase a coupon/voucher.

If it is determined that a referral has occurred, a referral incentive 312 may be identified and/or provided, as depicted at block 314. In some embodiments, the referral incentive is provided to the referring consumer's account with promotion coordinator 102 or

directly to the referring consumer. For example, promotion coordinator may issue credits (e.g., points redeemable for good and services, monetary value, etc.) to the referring consumer's account and/or may issue additional coupons or products/gifts to the referring consumer. In some embodiments, credits may be used for the purchase of additional coupons/vouchers. For example, the referring consumer's account may be issued $1.00 credit for each referral, such that receiving ten referrals associated with the consumer may entitle the referring consumer to a discount of $10 on their next coupon/voucher purchase. In some embodiments, credits may be applied to coupons/vouchers/products/gifts, etc. For example, the referring consumer may receive increases in value to the coupons they have already purchased or additional gifts (e.g., coupons/vouchers/products). In some embodiments, a referral incentive may include a donation to a charity or other organization. In some embodiments, a referral incentive may include “points” that are redeemable for various goods and services. Accordingly, consumers may be provided incentives to encourage referring others to participate in promotional offers provided by system 100. Where no referrals are received, or referrals have been processed, method 300 may proceed to monitoring and executing other operations of system 100.

Method 300 may include determining whether or not an offer time limit has expired, as depicted at block 316. An offer time limit may correspond to an open period in which consumers are able to purchased coupons/vouchers or otherwise indicate their desire to participate in a promotional offer. For example, in an embodiment in which consumer's are able to opt into an offer over ten days (e.g., between the dates of April 1^{st} and April 8^{th}), the offer time limit may expire at 12:00 am, April 9^{th}. Such a period may provide time for a number of consumers to purchase coupon/vouchers, may enable consumers to refer others to the coupon/voucher offer, and so forth. If it is determined that the time limit has not expired, system 100 may continue to provide coupon voucher offers, process purchases of coupon/voucher for the offer, process referrals, and so forth. Where it is determined that the offer time limit has expired, method 300 may proceed to monitoring and executing other operations of system 100. Determining whether or not an offer time limit has expired may be provided by promotion coordinator 102 (e.g., processing module 200), promotion instrument provider 104 and/or product provider 106.

Method 300 may include determining whether an incentive threshold has been met, as depicted at block 318. For example, where the offer time limit has expired, method 300 may include assessing and determining whether one or more incentive thresholds have been met. An incentive threshold may include a threshold value for the number and/or value of coupon/vouchers issued (e.g., sold) to consumers for the coupon/voucher offer 302 within the given time limit for the offer. In some embodiments, a threshold may be provided/set by a promotion coordinator 102, promotion instrument provider 104 and/or product provider 106. For example, a product provider 106 may determine/provide an incentive threshold based on an expected return on investment (e.g., when the expected amount of profit justifies issuing additional incentives). As described below, incentives may vary based on the number and/or value of coupons/vouchers issued.

In some embodiments, no additional incentives are provided if at least one of the one or more thresholds is not met. For example, where thresholds are set at two-hundred coupons/vouchers sold for a first level of incentive and three-hundred coupon vouchers sold for a second level of incentive, and less than two-hundred (e.g., only one-hundred fifty) coupons/vouchers are issued (e.g., sold) between April 1^{st} and April 9^{th}, it may be determined that the thresholds have not been met. As a result, no additional incentives may be provided in association with the coupon/vouchers for the offer. For example, the monetary redemption value for the coupon/vouchers issued to the consumers may remain the same. In the context of the coupon for a restaurant purchased for $5 with an initial monetary redemption value of $10, the assigned monetary redemption value may remain $10, and/or no other credits/incentives may be issued to the consumers.

In some embodiments, additional incentives are provided if a threshold is met. For example, where a threshold is set at two-hundred coupons/vouchers sold for a first level of incentive and three-hundred coupon vouchers sold for a second level of incentive, and two-hundred fifty coupons/vouchers are issued (e.g., sold) between April 1^{st} and April 9^{th}, it may be determined that at least the first threshold has been met. As a result, method may advance to identifying and providing incentives (e.g., threshold incentives) 324, as depicted at block 326. Additional incentives may be provided to the consumer in association with the coupon/vouchers. The incentives may vary based on the extent to which coupons/vouchers were distributed, such that incentives may be greater where a greater number and/or value of coupons/vouchers are issued during the specified time period for the coupon/voucher offer 302. For example, the first level of incentive (e.g., an additional $5 redemption value) may be issued based on meeting the first threshold. A second level of incentive (e.g., an additional $10 redemption value) may not be issued based on not meeting the second threshold, although the second level incentive may have been issued if three-hundred or more coupons/vouchers had been sold.

A threshold incentive may include assigning a monetary redemption value of a promotional instrument based on the number and/or value of promotional instruments issued/sold. For example, a redemption value of a coupon/voucher may increase based on an increased number and/or value of coupons/vouchers issued/sold. For example, where a coupon is purchased for $5 with an initial monetary redemption value of $10 toward a meal at a restaurant, and the incentive threshold is met, the monetary redemption value may be increased to $15 toward a meal at the restaurant.

A threshold incentive may include providing additional products based on the number and/or value of promotional instruments issued/sold. For example, a greater number of products/gifts (e.g., “add-ons”) may be provided to a consumer based on an increased number and/or value of coupons/vouchers issued/sold. For example, where a coupon is purchased for $5 with an initial redemption value of $10 toward a meal at a restaurant, and the incentive threshold is met, the consumer may be provided a free complementary desert.

A threshold incentive may include providing additional coupon/vouchers based on the number and/or value of promotional instruments issued/sold. For example, additional coupons/vouchers may be provided to a consumer based on an increased number and/or value of coupons/vouchers issued/sold. For example, where a coupon is purchased for $5 with an initial monetary redemption value of $10 toward a meal at a restaurant, and the incentive threshold is met, the consumer may receive another coupon/voucher for $2 toward the purchase of ice-cram at the desert shop neighboring the restaurant.

A threshold incentive may include providing additional credits the consumer's account based on the number and/or value of promotional instruments issued/sold. For example, a greater number of credits (e.g., points redeemable for good and services, monetary value, etc.) may be issued to the consumer's account with promotion system 100 based on an increased number and/or value of coupons/vouchers issued/sold. For example, where a coupon is purchased for $5 with an initial monetary redemption value of $10 toward a meal at a restaurant, and the incentive threshold is met, the consumer's account may be credited with “200 promotion points” that can be used toward the purchase of additional coupons/vouchers in the future and/or other products. One promotion points may be equivalent to $0.01 toward the purchase of coupons/voucher or other products. In some embodiments, coordinator 102 may include a credit system for tracking and issuing credits to a consumer's account and for enable the consumer to redeem the credits for monetary (e.g., cash), credits towards the purchase of goods and services, credits towards the purchase of other coupons/vouchers, and the like.

A threshold incentive may include a donation to a charity or other organization. For example, where a coupon is purchased for $5 with an initial monetary redemption value of $10 toward a meal at a restaurant, and the incentive threshold is met, a donation to a charity or other organization may be made on the consumer's behalf.

In some embodiments, multiple incentives can be combined. For example, where a coupon is purchased for $5 with an initial monetary redemption value of $10 toward a meal at a restaurant, and the incentive threshold is met, the monetary redemption value may be increased to $15 toward a meal at the restaurant, the consumer may be provided a free desert, the consumer may receive a coupon/voucher for $2 toward the purchase of ice-cram at the desert shop neighboring the restaurant, the consumer's account may be credited with “200 promotion points” that can be used toward the purchase of additional coupons/vouchers in the future and/or other products, and/or a donation may be made to a charity or other organization.

Varying levels of incentives may be provided based on the varying level of participation in the promotional offer. In some embodiments, the incentives increase with increased participation with the coupon/voucher offer. For example, as the number and/or value of coupons/vouchers issued (e.g., sold) increases, the redemption value of the coupon/voucher, the value/number of add-ons, the value/number of coupons/vouchers issued to the consumer, the value/number of credits, the value/number of donations and so forth may increase. In some embodiments, the number/value of incentives increase incrementally based on satisfying one or more of a plurality of incremental thresholds for the number and/or value of coupons sold. For example, the redemption value may increase by $1 for every fifty coupons/vouchers sold. Thus, if only forty coupons/vouchers are sold, the redemption value for a coupon/voucher may not increase. If seventy-five coupons/vouchers are sold, the redemption value for the coupon/voucher may increase from $10 to $11. If one-hundred twenty-five coupons/vouchers are sold, the redemption value for the coupon/voucher may increase from $10 to $12. In some embodiments, the number/value of incentives increases proportionally. For example, where the redemption value increases by 1% of the total value of coupons sold for $5 and having an initial redemption value of $10, forty coupons/vouchers are sold (i.e., a total value of $200), the redemption value for the coupon/voucher may increase by $2 (1% of $200), from $10 to $12. In some embodiments incentives may be limited to a maximum amount. For example, the redemption value may be limited to a maximum amount of $20. Similar increases in value and limits may be provided for other incentives. For example, the amount/value of products (e.g., add-ons), additional coupons/vouchers and/or credits (e.g., promotion points) may be subject to incremental and/or proportional increases and maximum limits.

In some embodiments, threshold incentives 324 may be identified and provided via system 100. For example, promotion coordinator 102 may determine the number and/or value of coupons/vouchers issued (e.g., sold) for coupon/voucher offer 302, and may determine the threshold incentive 324 based on a comparison of the number an/or value of coupons/vouchers issued (e.g., sold) to the threshold value specifying the number an/or value of coupons/vouchers issued to satisfy threshold requirement(s). A particular level of incentive may be issued based on the thresholds that are met. For example, the first level of incentive (e.g., an additional $5 redemption value) may be issued based on meeting a first threshold, a second level of incentive (e.g., an additional $10 redemption value) may be issued based on meeting a second threshold, and so forth. The threshold value may be provided by product provider 106.

Method 300 may include assigning incentives, as depicted at block 326. Assigning incentives may include associating incentives with coupon/vouchers and/or consumer accounts. For example, where a monetary redemption value is to be increased based on the identified threshold incentives, the increased monetary redemption value may be assigned to corresponding coupons/vouchers of the coupon/voucher offer such that increased redemption value is available to the consumer at the time of redemption. Assignment of incentives may be provided by promotion coordinator 102.

Entities may be notified of the assigned incentives (e.g., referral incentives and/or threshold incentives) such that consumer may be provided the appropriate level of incentive. For example, promotion coordinator 102 may notify promotion instrument provider 104, product provider 106, and/or consumer 108 of the determined incentives that are assigned to the consumer, the consumer's account and/or the promotion instrument. In some embodiments notification is provided in response to a query for the information. For example, upon redemption of coupon/voucher 306 by consumer 108 at product provider 106, product provider 106 may query promotional coordinator for the currently assigned incentives for coupon/voucher 306 and/or consumer 108, and promotion coordinator may respond by providing the currently assigned incentives (e.g., monetary redemption values, gifts/add-ons, and so forth).

Method 300 may include redeeming coupon/voucher 306 and/or other incentives, as depicted at block 328. Redeeming coupon/voucher 306 may include consumer 108 presenting coupon/voucher 306 to product provider 106 for credit toward the purchase of a product, the receipt of add-ons, credits and so forth. For example, restaurant coupon/voucher purchased for $5 and having an initial monetary redemption value of $10, that is subsequently increased to a monetary redemption value of $15 based on an incentive threshold being met, may be redeemed by the consumer for a $15 credit toward the purchase of a meal at the restaurant. In some embodiments, coupons/vouchers may need to be redeemed prior to an expiration date of the coupon/voucher.

Method 300 may include settling payments, as depicted at block 330. Settling payments may include distributing funds between various entities of system 100, including promotion coordinator 102, promotion instrument provider 104, product provider 106 and/or consumer 108. For example, where promotion instrument provider 104 has received payments from consumer 108, promotion instrument provider 104 may forward a corresponding payment to promotion coordinator 102, and promotion coordinator 102 may forward a corresponding payment to product provider 106. Payments may be subject to a commission. For example, where a 5% commission is to be paid to promotion instrument provider 104 and a 15% commission is to be paid to promotion coordinator 102, and the total amount of payments collected by promotion instrument provider 104 from consumers is $1000, promotion instrument provider 104 may forward a corresponding payment of $950 to promotion coordinator 102, and promotion coordinator 102 may forward a corresponding payment of $800 to product provider 106. In some embodiments, payments are to be settled within a given period of time (e.g., fifteen days of the expiration of the time limit for the coupon/voucher offer).

FIG. 4 depicts an exemplary computer system 1000 which may implement embodiments of the invention. Computer system 1000 may be operable to execute computer applications (e.g., promotion processing module 200) to implement promotions, as described herein. Computer system 1000 may include various components such as CPU 1002 and a memory medium 1004. Memory medium 1004 may include a tangible memory medium such as random access memory (RAM), flash memory, hard-drives, and/or CD-ROMs, or the like. Memory medium 1004 may include a storage medium having program instructions stored thereon that are executable to implement one or more embodiments of the present technique. The program instructions may be executable by CPU 1002 to implement one or more methods associated with the preset technique. In the illustrated embodiment, computer system 1000 includes a display device 1006 (e.g., a monitor), an alphanumeric input device 1008 (e.g., a keyboard), and a directional input device 1010 (e.g., a mouse). In some embodiments, computer system 1000 may include modular and plug-in boards/cards (e.g., with either commercially available or proprietary hardware) that may be added via a number of expansion slots internal or external to the computer body. Computer system 1000 may be connected to a network that enables communication with other computer systems and devices connected to the network. In some embodiments, computer system 1000 may be connected to the internet. For example, computer system 1000 may include a wired or wireless connection that provides access to the internet. Computer system 1000 may access the internet via a browser or similar application executed thereon.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Furthermore, note that the word “may” is used throughout this application in a permissive sense (i.e., having the potential to, being able to), not a mandatory sense (i.e., must). The term “include”, and derivations thereof, mean “including, but not limited to”. As used in this specification and the claims, the singular forms “a”, “an” and “the” include plural referents unless the content clearly indicates otherwise. Thus, for example, reference to “an instrument” may include a combination of two or more instruments. The term “coupled” means “directly or indirectly connected”.

What is claimed is:

1. A method for providing a promotional instrument, comprising:
determining a number and/or value of promotional instruments purchased; and
assigning, by a promotion system, a promotional incentive based at least in part on the number and/or value of promotional instruments purchased.

2. The method of claim 1, wherein the promotional instrument comprises a coupon and/or voucher.

3. The method of claim 1, wherein the promotional instrument is configured to be provided to a consumer in exchange for consideration received for the purchase of the promotional instrument.

4. The method of claim 1, wherein assigning a promotional incentive comprises increasing a monetary redemption value of the promotion instrument as the number and/or value of promotional instruments purchased increases.

5. The method of claim 4, wherein the promotional instrument is configured to be received from the consumer as at least partial consideration for the purchase of a product, and wherein at least a portion of the assigned monetary redemption value is configured to be applied to the purchase of the product.

6. The method of claim 1, wherein assigning a promotional incentive comprises:
identifying a promotional instrument purchase threshold;
determining whether the number and/or value of promotional instruments purchased satisfies the promotional instrument purchase threshold, and
assigning, upon determining that the number and/or value of promotional instruments purchased satisfies the promotional instrument purchase threshold, an incentive corresponding to the promotion instrument purchased.

7. The method of claim 6, further comprising, upon determining that the number and/or value of promotional instruments purchased does not satisfy the promotional instrument purchase threshold, not assigning an incentive.

8. The method of claim 1, wherein the promotional incentive comprises an increase in a redemption value of one or more of the promotional instruments purchased.

9. The method of claim 1, wherein the promotional incentive comprises a credit deposited within an account associated with one or more consumers that purchased one or more of the promotional instruments.

10. The method of claim 1, wherein the promotional incentive comprises additional products to be provided to the consumer.

11. The method of claim 1, wherein the promotional incentive comprises a credit applicable to the purchase of additional promotional instruments.

12. The method of claim 1, wherein the promotional incentive comprises a monetary donation to a third party.

13. The method of claim 1, wherein determining a number of promotional instruments purchased comprises determining a number of promotional instruments purchased within a given period of time.

14. The method of claim 1, wherein the assigned incentive increases in value and/or quantity with an increased number and/or value of promotional instruments purchased.

15. The method of claim 1, further comprising:
determining whether a consumer has referred another consumer to purchase one or more of the promotional instruments, and
providing, upon determining that the consumer has referred another consumer to purchase one or more of the promotional instruments, an incentive to the consumer.

16. The method of claim 1, further comprising providing a payment to one or more providers, wherein the payment corresponds to at least a portion of consideration received for the purchase of promotional instruments.

17. The method of claim 16, further comprising withholding a commission from the payment.

18. The method of claim 1, wherein the promotional instrument is provided to a consumer via an electronic transmission network.

19. A non-transitory computer readable storage medium comprising program instructions stored thereon, wherein the program instructions are executable by a computer device to cause:
determining a number and/or value of promotional instruments purchased; and
assigning a promotional incentive based at least in part on the number and/or value of promotional instruments purchased.

20. A system for conducting promotions, comprising:
a promotional instrument coordinator comprising a processing module configured to:
determine a number and/or value of promotional instruments purchased; and
assign a promotional incentive based at least in part on the number and/or value of promotional instruments purchased.
